(19) United States
(12) Patent Application Publication
(10) Pub. No.: US 2010/0291507 A1
(43) Pub. Date: Nov. 18, 2010

(54) Polyaxial Dental Implant

(75) Inventor: Mahmoud F. Abdelgany, Rockaway, NJ (US)

Correspondence Address: Rahman LLC;Mohammad Rahman, 10025 Governor Warfield Parkway, Suite 110, Columbia, MD, 21044, US

(73) Assignee: CUSTOM SPINE, INC., Parsippany, NJ (US)

(21) Appl. No.: 12/465,081

(22) Filed: May 13, 2009

(51) Int. Cl. A61C 8/00

(52) U.S. Cl. 433/174

(57) ABSTRACT

A polyaxial dental implant includes an abutment member that includes a channel bored through a longitudinal axis of the abutment member, and an outwardly protruding and expandable round bulbous body coupled to an end of the abutment member. The implant includes a fixture member coupled to the bulbous body, where the fixture member receives the bulbous body; and a pin engaged within the abutment member via the channel and contacting the bulbous body causing the bulbous body to outwardly expand into the fixture member.

### BACKGROUND

1. Technical Field

The embodiments herein generally relate to endosseous dental implants, and, more particularly, to an abutment used to secure a dental prosthesis to an implant fixture.

2. Description of the Related Art

A conventional dental implant device typically consists of two components: an implant fixture and an abutment. An implant fixture is imbedded into a patient's maxilla or mandible bone. An abutment is connected to the fixture and typically forms a support for a prosthesis; i.e., a crown, denture, partial bridge, or bridge. The implant fixture may be surgically implanted into the bone at various angles depending on several factors, such as the number of implants being placed into a corresponding section of edentulous (toothless) bone; the portion of the edentulous bone best suited to successfully support the implant; and the angle chosen by the dental professional in placing the implant. The abutment, however, must be aligned so that the dental prosthesis it will receive is generally parallel with other surrounding teeth, regardless of the angle at which the implant fixture is placed in the bone.

Conventionally, abutments include a substantially axisymmetric base portion, which fits into a hole formed in the implant fixture, and a conical neck portion, which projects outward from the base portion of the abutment. The typical abutment, however, is often unwieldy, due to the number of separate components, and frequently results in prolonging the patient's exposure to anesthesia. Besides securing the prosthesis to the implant fixture, the abutment also compensates, with varying success, for any misalignment between the prosthesis and adjacent teeth. Misalignment can arise, for example, when the implant fixture has an orientation with respect to the gum surface that is substantially different than the adjacent teeth.

Implant assemblies often employ angled abutments, as opposed to straight abutments, to account for any misalignment. As a consequence, a dental practitioner typically has a large inventory of abutments; angled in varying degrees, as well as different sizes, to accommodate the limitations of the convention dental implant. Straight and angled abutments have neck portions that project outward from their base portions in directions that are, respectively, substantially parallel or non-parallel to the symmetry axes of their corresponding base portions. Therefore, if the direction or orientation of the neck portion of the abutment is represented by a longitudinal axis that intersects the symmetry axis of the base portion (or implant fixture); the resulting orientation angle is about zero for straight abutments. In contrast, an angled abutment exhibits a non-zero orientation angle.

Though widely accepted by dental practitioners, dental implants generally, and root-form implants in particular, are not without problems. For example, the neck portions of commercially available angled abutments have fixed angular displacements with respect to their base portions, which limit their usefulness. Once a patient has been fitted with an implant fixture, the dental practitioner must either have the implant fixture readily available or order an abutment having the requisite orientation angle to ensure proper alignment of the prosthesis. However, since only discrete orientation angles are available, it is often necessary to modify the abutment to achieve the requisite angular orientation, which can be a labor intensive and costly process. In some cases the necessary orientation angle may be significantly greater than what is commercially available, making it difficult to attain acceptable alignment of the prosthesis.

Most of the disclosed implants are limited to modest orientation angles of about twenty-five degrees or less, and many do not readily permit removal of the prosthesis following installation. Some of the disclosed implants also fail to provide a smooth transition between the prosthesis and the implant fixture, which results in poor soft tissue adaptation. To ensure accurate alignment of the prosthesis with adjacent teeth, current practice provides for fabricating an abutment and prosthesis from a cast of the patient's mouth following insertion of the implant fixture. Some of the disclosed designs, however, do not include a mechanism for attaching the prosthesis to the abutment prior to installation, and therefore cannot take advantage of using a laboratory cast, if desired.

### SUMMARY

In view of the foregoing, an embodiment herein provides a polyaxial dental implant device comprising an abutment member comprising a channel bored through a longitudinal axis of the abutment member; and an outwardly protruding and expandable round bulbous body coupled to an end of the abutment member; a fixture member coupled to the bulbous body, wherein the fixture member receives the bulbous body; and a pin engaged within the abutment member via the channel and contacting the bulbous body causing the bulbous body to outwardly expand into the fixture member.

The fixture member further comprises a concave socket that receives the bulbous body of the abutment member. The fixture member may also comprise a threaded end opposite the concave socket. Moreover, the fixture member may comprise an outer wall with grooves etched therein. Additionally, the fixture member may comprise an outer wall with grooves etched therein. Furthermore, the fixture member may comprise a Morse-type taper.

In addition, the abutment member may comprise a substantially planar lower surface, wherein the bulbous body extends from the lower surface of the abutment member, and wherein the concave socket cups the expandable bulbous body and allows the bulbous body to rotate polyaxially with respect to the fixture member. Moreover, the abutment member may comprise a wall completely circumferentially encircling the channel. Furthermore, the bulbous body of the abutment member may comprise a plurality of slots separating a plurality of bendable flanges of the bulbous body. Additionally, the abutment member is configured as a dental prosthesis comprising a receptacle that receives a deformable head cap. Moreover, the channel may comprise threads. Additionally, each of the channel and the pin may be tapered.

A polyaxial dental implant apparatus is further provided comprising an abutment member comprising a channel bored through a longitudinal axis of the abutment member; and an outwardly protruding and expandable round bulbous body coupled to an end of the abutment member; a fixture member coupled to the bulbous body, wherein the fixture member receives the bulbous body; a pin engaged within the abutment member via the channel and contacting the bulbous body causing the bulbous body to outwardly expand into the fixture member; and a deformable head cap positioned over the abutment member, wherein the fixture member is dynamically positioned at a different longitudinal axis than the longitudinal axis of the head cap.

In such an apparatus, the fixture member may further comprise a concave socket that receives the bulbous body of the abutment member. In addition, the fixture member may comprise a threaded end opposite the concave socket. Moreover, the fixture member may comprise a Morse-type taper.

Furthermore, in such an apparatus, the abutment member may comprise a substantially planar lower surface, wherein the bulbous body extends from the lower surface of the abutment member, and wherein the concave socket cups the expandable bulbous body and allows the bulbous body to rotate polyaxially with respect to the fixture member. Moreover, the abutment member may comprise a wall completely circumferentially encircling the channel. Additionally, the abutment member may comprise a dental prosthesis comprising a receptacle that receives the deformable head cap.

In addition, a method of performing a dental procedure is provided, the method comprising inserting a fixture member into an alveolar bone, wherein the fixture member comprises a concave socket; connecting an abutment member to the fixture member, wherein the abutment member comprises a channel bored through a longitudinal axis of the abutment member; and an outwardly protruding and expandable round bulbous body coupled to the concave socket. The method further comprises inserting a pin through the channel of the abutment member and contacting the bulbous body causing the bulbous body to outwardly expand into the concave socket of the fixture member and lock the abutment member to the fixture member; and positioning a deformable head cap over the abutment member, wherein the fixture member is dynamically positioned at a different longitudinal axis than the longitudinal axis of the head cap. In addition, the method is also provided where the abutment member comprises a dental prosthesis comprising a receptacle that receives the deformable head cap.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The embodiments herein will be better understood from the following detailed description with reference to the drawings, in which:

FIG. 1 illustrates a perspective view of a dental implant, according to an embodiment described herein;

FIG. 2 illustrates a perspective view of a fixture, according to an embodiment described herein;

FIG. 3 illustrates a cross-sectional view of a fixture, according to an embodiment described herein;

FIG. 4 illustrates a perspective view of an abutment, according to an embodiment described herein;

FIG. 5 is a cross-sectional view of an abutment with a dental prosthetic cap, according to an embodiment described herein;

FIG. 6(A) illustrates a bottom view of the bulbous end of an abutment of FIGS. 4 and 5 according to an embodiment described herein;

FIG. 6(B) illustrates a detailed view of an abutment, according to an embodiment described herein;

FIG. 7 illustrates a perspective view of a securing pin according to an embodiment described herein; and

FIG. 8 is a flow diagram illustrating a preferred method according to an embodiment herein

### DETAILED DESCRIPTION OF PREFERRED EMBODIMENTS

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

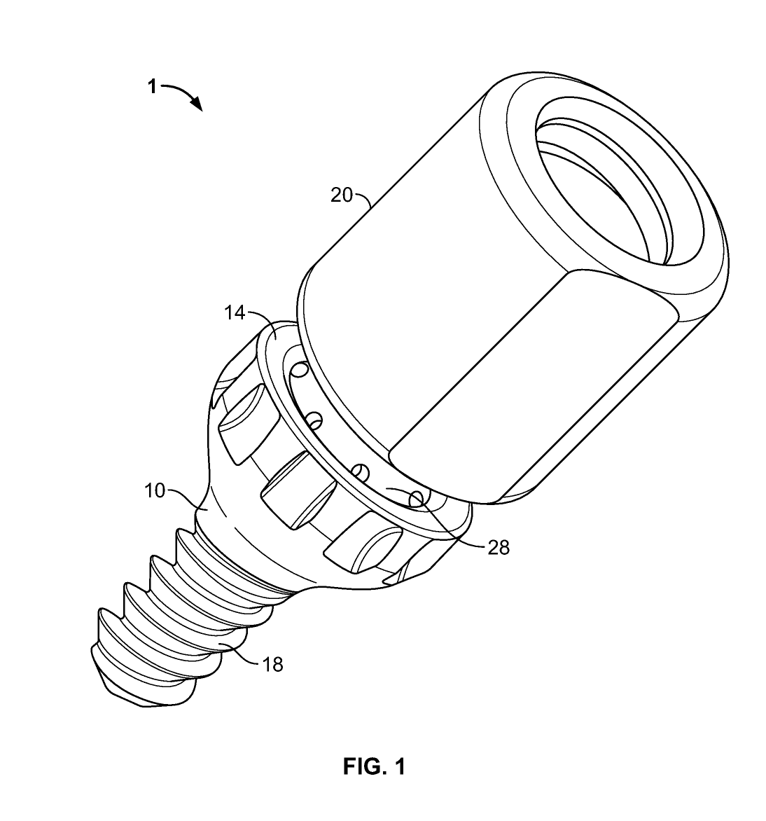

The embodiments herein provide an improved dental implant device with fewer components than conventional systems and a method of assembly capable of simplifying a surgical procedure using such an improved dental implant device. The improved dental implant assembly overcomes the limitations of the conventional designs thereby providing the dental practitioner with improved intra-operative flexibility and the patient with an improved prognosis for better and complete rehabilitation. Referring now to the drawings and, more particularly to FIGS. 1 through 8, where similar reference characters denote corresponding features consistently throughout the figures, there are shown preferred embodiments.

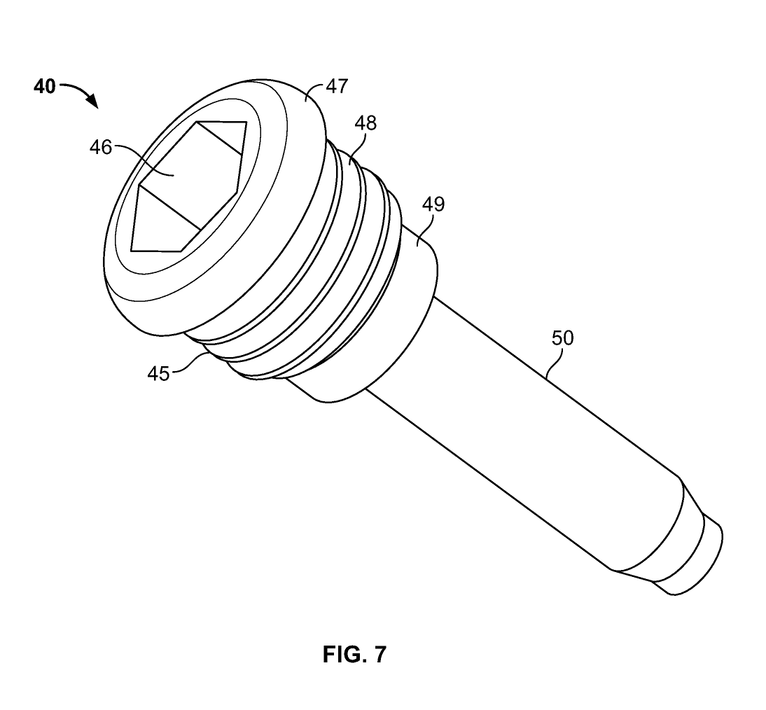

FIG. 1 illustrates a perspective view of a dental implant assembly 1. Dental implant assembly 1 includes fixture member 10 and abutment member 20. Fixture member 10 is shown having a threaded end 18 for engaging a bone (e.g., the lower maxilla or mandible bone, not shown in FIG. 1) and a concave female socket 14 for engaging and receiving the bulbous body 28 of abutment member 20 (as described in further detail below). Abutment member 20 is shown in just one of many possible configurations available for an abutment member, several more are discussed below. Accordingly, those skilled in the art, however, would recognize that other abutment member configurations are possible including abutment shaped to resemble various adults' or children's teeth. Consequently, the embodiments described below do not limit alternative embodiments of abutment member 20, specifically, or the polyaxial dental implant assembly 1, in general. During the manufacturing process, the dental assembly 1 may be prepared for transport by securing abutment member 20 to fixture member 10 via the securing pin 40 (of FIG. 7) and subjecting dental assembly 1 to ultra sonic cleaning. In so doing, any impurities are removed from dental assembly 1 and subsequently may be shipped in this manufactured format.

Optionally, a load-bearing component (not shown) such as a washer or other similar mechanism may be positioned in between the bulbous body 28 and the concave socket 14 to provide further controlled motion of the abutment member 20 with respect to the fixture member 10.

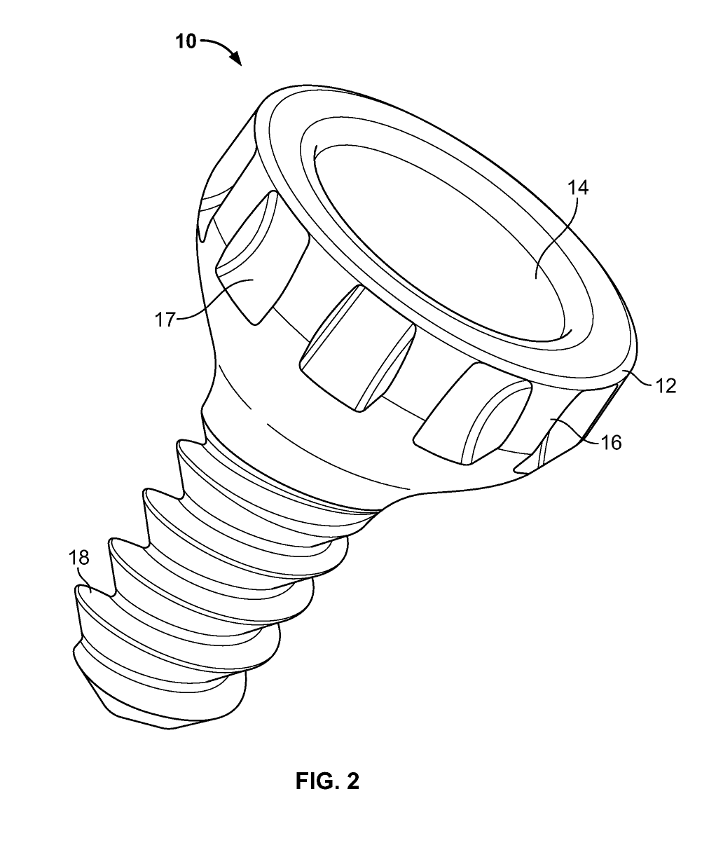

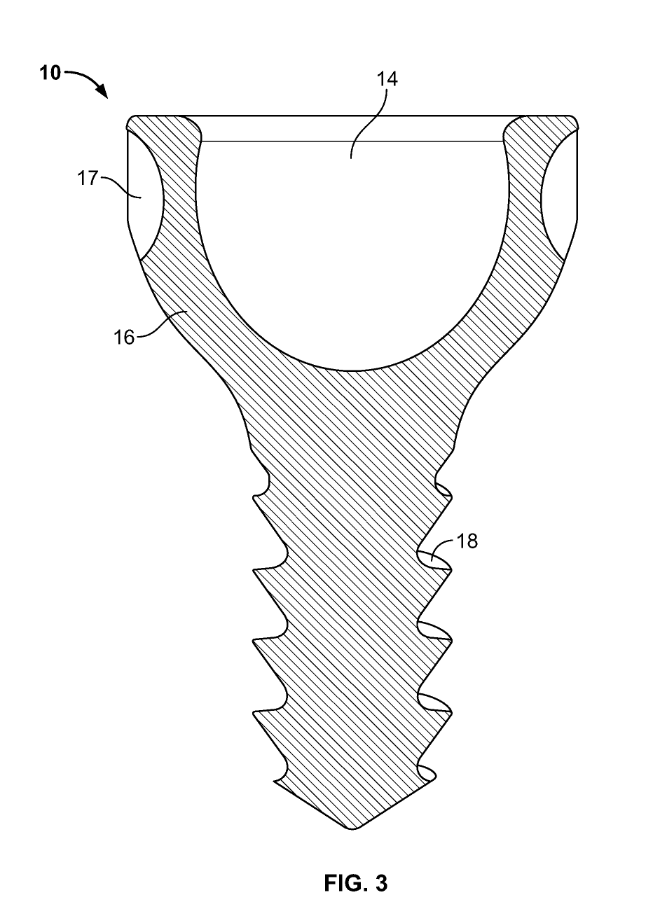

FIGS. 2 and 3, with reference to FIG. 1, show various views of fixture member 10. As shown in FIG. 2, fixture member 10 includes upper portion 12, female socket 14, outer shell 16, and threaded portion 18. Socket 14 is configured to allow the abutment member 20 (e.g., see FIG. 1) to pivot freely but not to disassemble once the bulbous body 28 is inserted and engaged within the socket 14. As shown in FIG. 3, outer shell 16 may include dimples 17 embedded therein. In addition, according to one embodiment of fixture member 10, the maximum angulation for each socket 14 is approximately 25 degrees/side, and the medial correction/travel of an abutment member 20 is approximately 3.8 mm/side, which is nearly twice of what most conventional implants offer.

Situated below upper portion 12 is threaded portion 18, which includes threads to engage different biological matter—e.g., gums, tissue, bone, etc. While not shown in FIGS. 2 and 3, threaded portion 18 may be a multiple lead thread to allow faster insertion into biological matter. Threaded portion 18 may also be tapered on the minor diameter while cylindrical on the major diameter to allow a new “bite” with every turn and to accommodate more thread depth towards the bottom of fixture member 10 for biological matter. For example, threaded portion 18 may be double lead, which provides greater surface contact with biological matter, but drives at 4 mm/revolution. In addition, while not shown in FIGS. 2 and 3, threaded portion 18 may further include a Morse-type taper.

Fixture member 10 may be fabricated from titanium or a titanium alloy to resemble a screw or a tooth root (not shown) with a roughened or smooth surface. For example, a suitable titanium alloys may include, but is not limited to, a derived Ti₆A₁V₄ compound.

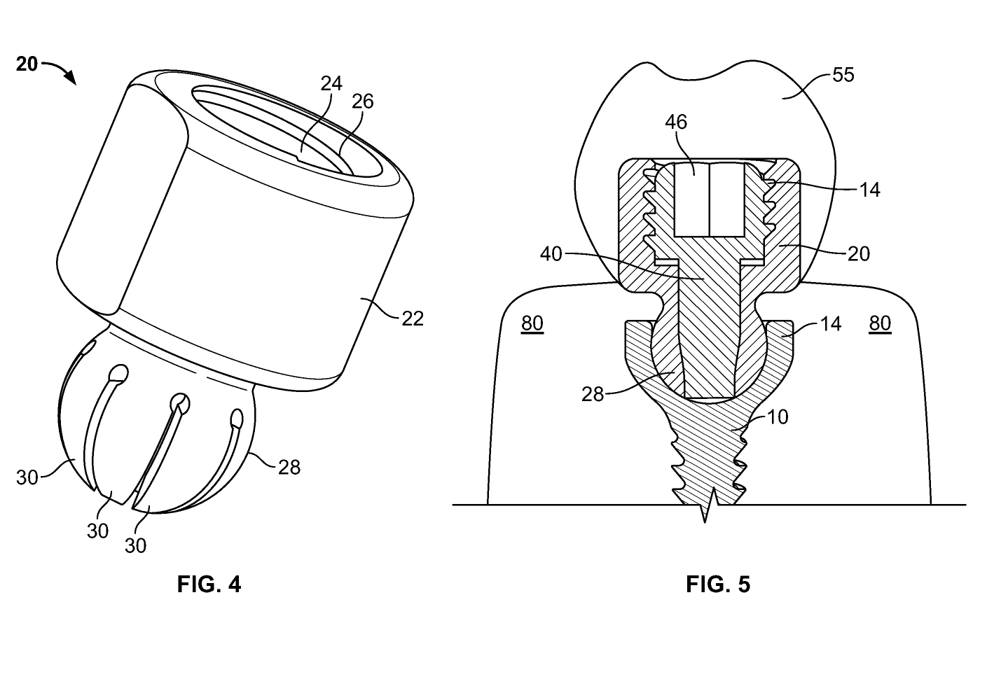

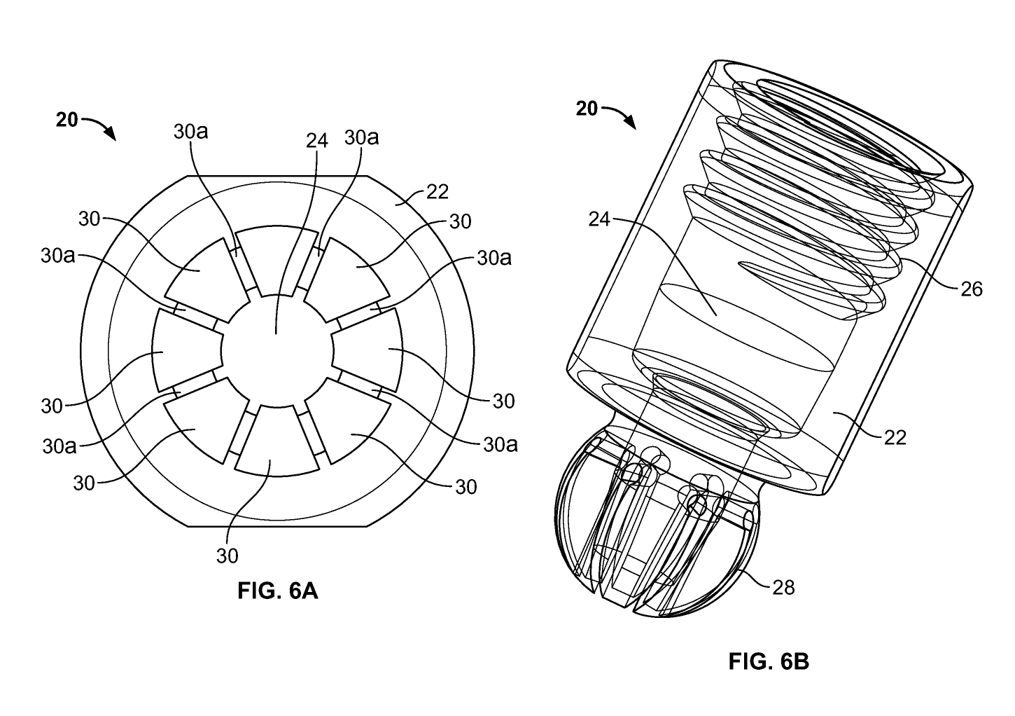

FIGS. 4 through 6(B), with reference to FIGS. 1 through 3, illustrate various views of abutment member 20. As shown in FIG. 4, abutment member 20 includes a main body 22, a securing channel 24, and a bulbous body 28. Bored in main body 22 is securing channel 24, which is shown in FIGS. 4 and 6(B) with optional threads 26 etched thereon. In addition, bulbous body 28 includes a plurality of slotted flanges 30 that allow bulbous body 28 to expand when engaged within spherical female socket 14 of fixture member 10 at any allowable angle once the securing pin 40 (of FIG. 7) is forced through. Since abutment member 20 is pivoting inside the female socket 14 of fixture member 10, dental implant assembly 1 is allowed to be inserted deeper into the biological matter without having the bone or anatomy prematurely limit the range of angulations of abutment member 20.

FIG. 5, with reference to FIGS. 1 through 4, illustrates a cross-sectional view of abutment member 20 with dental prosthesis 55. As shown, the fixture member 10 is implanted in bone 80 and the dental prosthesis may be molded to form any tooth in the human body. Techniques for creating molds in the form of human teeth, as shown in FIG. 5, are well know to those skilled in the art and will not be discussed herein further. Also shown in FIG. 5 is dental prosthesis 55 coupled to abutment member 20. While not shown in FIG. 5, dental prosthesis 55 may be coupled to abutment member 20 via mechanical means (e.g., threading on the exterior abutment member 20 configured to mate with threading on the interior of dental prosthesis 55 or a cavity in dental prosthesis 55 configured to securely couple to abutment member 20) or chemical means (e.g., application of a dental adhesive to bond dental prosthesis 55 to abutment member 20). In addition, FIG. 5 shows abutment member secured to fixture member via bulbous body 28 and securing pin 40 embedded (by applying a torque fastening socket 46) into securing channel 24 to force bulbous body 28 to expand in socket 14 of fixture member 10.

As shown in FIG. 6(A), with reference to FIGS. 1 through 5, abutment member 20 includes the expandable bulbous (or generally spherical) male body 28 for engaging the concave female socket 14 of fixture member 10. A plurality of axially spaced slots 32 are cut into bulbous body 28 forming a plurality of flanges 30, which expand once securing pin 40 (of FIG. 7) is forced through securing channel 24 and cause the flanges 30 to outwardly project and expand. As a consequence, bulbous body 28 expands into female spherical socket 14 of fixture member 10 at any allowable angle and thereby securing abutment member 20 to fixture member 10 via bulbous body 28. FIG. 6(B) illustrates, with reference to FIGS. 1 through 6(A), a detailed view of abutment member 20. As shown, securing channel 24 is preferably configured as a substantially vertical bore (i.e., with respect to the longitudinal axis of main body 22) through the center of main body 22 and optionally bulbous body 28. Techniques for creating such bores as shown in FIG. 4 are well know to those skilled in the art and will not be discussed herein further. As described in further detail below, securing channel 24 is optionally etched with threads 26, where threads 26 configured to mate with threads embedded in securing pin 40 (of FIG. 7).

FIG. 7, with reference to FIGS. 1 through 6(B), illustrates a prospective view of securing pin 40. As shown, securing pin 40 includes an upper fastening portion 45 and a lower tip portion 50. Upper fastening portion 45 further includes fastening socket 46, pin head 47, threads 48, and connecting ring 49. As shown, fastening socket 46 is a hexagonal shape. Those skilled in the art would recognize that other configurations are possible—for example, fastening socket 46 may be square or any other polygonal shape or may be a linear slit or cross-slit in pin head 47. Threading 48 is embedded around an outer perimeter of upper fastening portion 45 and is configured to engage threads 26 etched into the inner perimeter of securing channel 24 of abutment member 20. Connecting ring 49 is coupled to both the upper fastening portion 45 and lower tip portion 50. When upper fastening portion 45 and lower tip portion 50 are composed of different materials (as described in further detail below), connecting ring 49 provides additional strength in the coupling thereof.

Securing pin 40 may also comprise a multi-part assembly. For example, the upper fastening portion 45 of securing pin 40 may comprise titanium and the lower tip portion 50 of the securing pin 40 may comprise a ceramic material. Additionally, the lower tip portion 50 may comprise a mechanically harder material than the upper fastening portion 45. In such a configuration, fixture member 10 and abutment member 20 may optionally comprise a first material, and the lower tip portion 50 of the pin 40 may comprise a material having a higher material hardness and compressive yield strength than the first material. Moreover, dental implant assembly 1 may further comprise a wear resistant ceramic coating (not shown) over fixture member 10 and abutment member 20.

While not shown in FIGS. 1 through 7, dental implant assembly 1 can also be used as a dynamic multi-implant system (including, but not limited to various denture, partial bridge, or bridge systems) to complement existing structures (e.g., surrounding teeth or previous implants). According to this aspect of the embodiments herein, the outside of several bulbous bodies 28 and the inner spherical surface of female sockets 14 are coated with a wear resistant ceramic coating. In this scenario, each securing pin 40 is not digging into a corresponding fixture member 10 and in fact is configured at a shorter length than some of the other embodiments. This allows some motion instead of rigid fixation to increase the functional life of the bridge system. For example, this occurs as a result of the ceramic coating, which may be used in the embodiments herein. As such, the bulbous body 28 of abutment member 20 and the female socket 14 of fixture member 10 has a lower friction and higher wear resistance characteristics, thus improving the overall movement characteristics of the dental implant assembly 1.

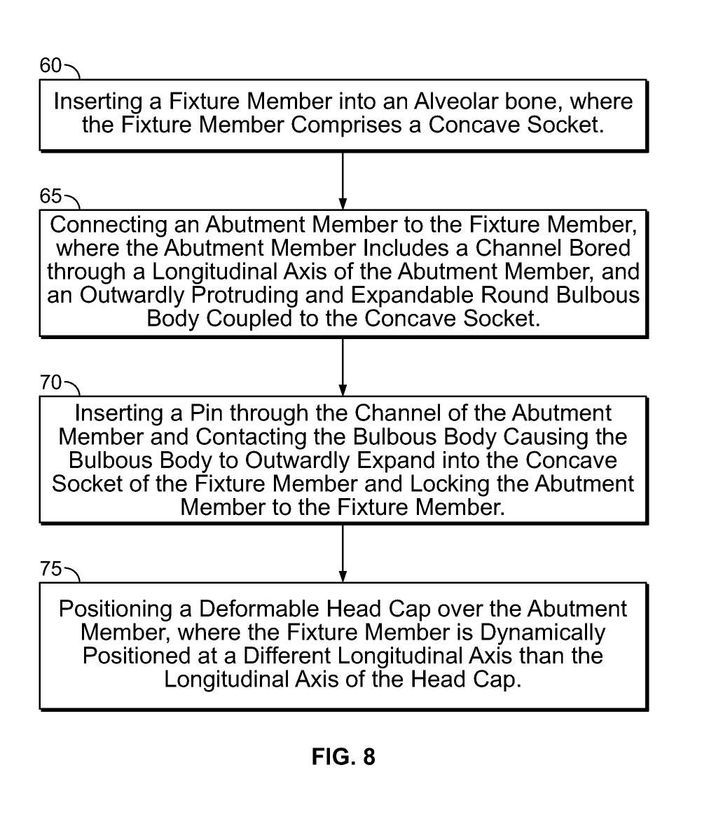

FIG. 8, with reference to FIGS. 1 through 7, is a flow diagram illustrating a method of performing a dental procedure according to an embodiment herein. The method comprises inserting (60) a fixture member 10 into an alveolar bone 80, where the fixture member 10 comprises a concave socket 14. The method of FIG. 8 further describes connecting (65) an abutment member 20 to the fixture member 10, where the abutment member 20 includes a channel 24 bored through a longitudinal axis of the abutment member 20, and an outwardly protruding and expandable round bulbous body 28 coupled to the concave socket 14. Next, the method of FIG. 8 describes inserting (70) a pin 40 through the channel 24 of the abutment member 20 and contacting the bulbous body 28 causing the bulbous body 28 to outwardly expand into the concave socket 14 of the fixture member 10 and locking the abutment member 20 to the fixture member 10. Thereafter, a deformable head cap 55 is positioned (75) over the abutment member 20, where the fixture member 10 is dynamically positioned at a different longitudinal axis than the longitudinal axis of the head cap 55.

The method described in FIG. 8 may also be performed by an automatic apparatus, or an otherwise non-human device, or encoded within a computer-readable medium. Automatic devices may include, for example, a robotic arm or remote controlled automata. In general, such devices may assist a human operator or be fully automated (i.e., without the aid of human input). Example of the former include surgical procedures performed via a remote control and devices used in telemedicine or teledentistry, while examples of the latter include a robotic surgeon and nursing robots, which are fully automated but assist a human dental practitioner or surgeon.

The embodiments herein provide a dental implant screw assembly 1 that can become rigid similar to a monoaxial implant inter-operatively on demand. The embodiments herein also offer the oral surgeon or dental practitioner more lateral range of motion than conventional products by utilizing the space under abutment member 20 to provide a bigger arc of rotation. The embodiments herein also allow for polyaxial direct connection from abutment member 20 to fixture member 10. Furthermore, by reducing the amount of components, and therefore the amount of foreign materials to be implanted during the surgical procedure, the embodiments herein provide a patient with an improved prognosis for better and faster rehabilitation.

In addition, the embodiments described herein allow a dental practitioner or surgeon to implant fixture member 10 (e.g., a bone anchor) in an ideal place and trajectory where optimal fixation may occur and allow the prosthetic “cap” (e.g., prosthetic cap 55 that has been formed in the shape of a human tooth) to be on a different trajectory for functionality and atheistic purposes. Furthermore, the embodiments described herein allow for a time delay to permit fixture member 10 to properly fuse with biological material (e.g., bone 80) and implantation of the prosthetic cap 55. Moreover, fixture member 10 allows burial of the fixture member 10 to a deeper level (e.g., burial into bone 80 up to upper portion 12) that helps prevent loosening (or fishtailing) of the implant 1 as repeated forces are exerted on the cap 55 and the dental implant assembly 1 in general, and provides a superior fitting for the life of the implant 1 compared to exiting dental implants.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

What is claimed is:

1. A polyaxial dental implant device comprising:
an abutment member comprising:
a channel bored through a longitudinal axis of said abutment member; and
an outwardly protruding and expandable round bulbous body coupled to an end of said abutment member;
a fixture member coupled to said bulbous body, wherein said fixture member receives said bulbous body; and
a pin engaged within said abutment member via said channel and contacting said bulbous body causing said bulbous body to outwardly expand into said fixture member.

2. The device of claim 1, wherein said fixture member further comprises a concave socket that receives said bulbous body of said abutment member.

3. The device of claim 2, wherein said abutment member comprises a substantially planar lower surface, wherein said bulbous body extends from said lower surface of said abutment member, and wherein said concave socket cups said expandable bulbous body and allows said bulbous body to rotate polyaxially with respect to said fixture member.

4. The device of claim 2, wherein said fixture member comprises a threaded end opposite said concave socket.

5. The device of claim 1, wherein said fixture member comprises an outer wall with grooves etched therein.

6. The device of claim 1, wherein said abutment member comprises a wall completely circumferentially encircling said channel.

7. The device of claim 1, wherein said fixture member comprises a Morse-type taper.

8. The device of claim 1, wherein said bulbous body of said abutment member comprises a plurality of slots separating a plurality of bendable flanges of said bulbous body.

9. The device of claim 1, wherein said channel comprises threads.

10. The device of claim 1, wherein each of said channel and said pin is tapered.

11. The device of claim 1, wherein said abutment member is configured as a dental prosthesis comprising a receptacle that receives a deformable head cap.

12. A polyaxial dental implant apparatus comprising:
an abutment member comprising:
a channel bored through a longitudinal axis of said abutment member; and
an outwardly protruding and expandable round bulbous body coupled to an end of said abutment member;
a fixture member coupled to said bulbous body, wherein said fixture member receives said bulbous body;
a pin engaged within said abutment member via said channel and contacting said bulbous body causing said bulbous body to outwardly expand into said fixture member; and
a deformable head cap positioned over said abutment member, wherein said fixture member is dynamically positioned at a different longitudinal axis than the longitudinal axis of said head cap.

13. The apparatus of claim 12, wherein said fixture member further comprises a concave socket that receives said bulbous body of said abutment member.

14. The apparatus of claim 13, wherein said abutment member comprises a substantially planar lower surface, wherein said bulbous body extends from said lower surface of said abutment member, and wherein said concave socket cups said expandable bulbous body and allows said bulbous body to rotate polyaxially with respect to said fixture member.

15. The apparatus of claim 13, wherein said fixture member comprises a threaded end opposite said concave socket.

16. The apparatus of claim 12, wherein said abutment member comprises a wall completely circumferentially encircling said channel.

17. The apparatus of claim 12, wherein said fixture member comprises a Morse-type taper.

18. The apparatus of claim 12, wherein said abutment member comprises a dental prosthesis comprising a receptacle that receives said deformable head cap.

19. A method of performing a dental procedure, said method comprising:
inserting a fixture member into an alveolar bone, wherein said fixture member comprises a concave socket;
connecting an abutment member to said fixture member, wherein said abutment member comprises:
a channel bored through a longitudinal axis of said abutment member; and
an outwardly protruding and expandable round bulbous body coupled to said concave socket;
inserting a pin through said channel of said abutment member and contacting said bulbous body causing said bulbous body to outwardly expand into said concave socket of said fixture member and lock said abutment member to said fixture member; and
positioning a deformable head cap over said abutment member, wherein said fixture member is dynamically positioned at a different longitudinal axis than the longitudinal axis of said head cap.

20. The method of claim 19, wherein said abutment member comprises a dental prosthesis comprising a receptacle that receives said deformable head cap.
